(19) United States
(12) Patent Application Publication
(10) Pub. No.: US 2017/0249634 A1
(43) Pub. Date: Aug. 31, 2017

(54) VALIDATING A SHORT-RANGE MOBILE DEVICE TRANSACTION USING A LONG-RANGE MOBILE DEVICE TRANSACTION

(71) Applicant: LINQ3 TECHNOLOGIES LLC, New York, NY (US)

(72) Inventors: Daniel Cage, Atlanta, GA (US); John Minutaglio, Atlanta, GA (US); Christopher Jon Little, Los Angeles, CA (US); Roy Leach, New York, NY (US)

(21) Appl. No.: 15/055,866

(22) Filed: Feb. 29, 2016

(51) Int. Cl. G06Q 20/40; G06Q 20/32

(52) U.S. Cl. CPC G06Q 20/401; G06Q 20/3278; G06Q 20/3224

(57) ABSTRACT

An exemplary device is a device is for validating a short-range mobile device transaction using a long-range mobile device transaction. The device comprises a first communication interface; a second communication interface; and a processor configured to: receive a first request from the device, the first request being associated with an application; conduct, over the first communication interface, a first transaction, the first transaction comprising transmission or reception of first information over the first communication interface, and send, over the second communication interface, a second request associated with the application, the second request being based on the first transaction. The second request is processed based on: determining a location associated with conducting the first transaction or sending the second request, and determining the location is an approved location associated with the application.

### TECHNICAL FIELD

This disclosure generally relates to mobile devices.

### BACKGROUND

There is a need for an innovative solution to validate transmission of information from a mobile device and/or reception of information at the mobile device.

### SUMMARY

In some embodiments, a device is provided for approving application-based transactions. The device comprises a first communication interface, the first communication interface comprising a wireless interface (e.g., Bluetooth interface such as a Bluetooth Low Energy (BLE) interface); a second communication interface; and a processor configured to: receive a first request from a user of the device, the first request being associated with an application; conduct, over the first communication interface, a first transaction, the first transaction comprising reception of first information over the first communication interface, and send, over the second communication interface, a second request associated with the application. The first request or the second request is approved based on: determining a location associated with conducting the first transaction or sending the second request, and determining the location is an approved location associated with the application.

In some embodiments, the device is further configured to prompt a user of the device to execute the application in response to determining the device is with a threshold distance of a beacon with which the first transaction is conducted. In some embodiments, the beacon may be a Bluetooth interface such as BLE terminal.

In some embodiments, the second communication interface comprises a Wi-Fi or cellular interface.

In some embodiments, the device is comprised in or part of a motor vehicle.

In some embodiments, the second request comprises at least one of a purchase request, the first request, or the first information.

In some embodiments, the location is determined based on global positioning system (GPS) coordinates of the device.

In some embodiments, the device comprises a mobile device or a non-mobile device.

In some embodiments, the second request is approved further based on determining a period of validity associated with the first information has not expired.

In some embodiments, the second request is approved further based on: determining an authority associated with the application; and determining the user is located in an approved jurisdiction associated with the authority for the application.

In some embodiments, the location is determined based on input received at the device.

In some embodiments, the second communication interface is associated with longer range communication compared to the first communication interface.

In some embodiments, the location is determined by at least one of the device or by a second device that receives the second request from the device.

In some embodiments, a method is provided for processing application-based transactions. The method comprises receiving information associated with an application-based transaction conducted, via a Bluetooth interface such as a BLE interface, between a user device and an application-based terminal, wherein the application-based transaction is associated with a request for executing an application; determining a location of the user device associated with the application; determining the user device is located in an approved location associated with the application; and processing the application-based transaction based on determining the user device is located in the approved location associated with the application. The application-based transaction is conducted on a first communication interface, and the information associated with the application-based transaction is received on a second communication interface.

In some embodiments, the user device comprises an application-based application.

In some embodiments, the application comprises a lottery application.

In some embodiments, the method further comprises determining a period of validity associated with the information has not expired, and processing the application-based request based on determining the period of validity associated with the information has not expired.

In some embodiments, the method further comprises processing the application-based transaction based on: determining a merchant associated with the location of the user device or the application-based terminal; cross-referencing a list of approved merchants associated with the location of the user device or the application- based terminal; and determining the merchant is present on the list of approved merchants.

In some embodiments, the application-based terminal comprises either an electronic application-based terminal or a non-electronic application executing terminal.

In some embodiments, another device is provided for processing application-based transactions. The device is configured to receive information associated with an application-based transaction conducted, via a Bluetooth interface such as a BLE interface, between a user device and an application-based terminal, wherein the application-based transaction is associated with a request for executing an application using the user device; and process the application-based transaction based on determining the user device is located in an approved location associated with the application, wherein the location of the user device is determined either by the device or the user device. The application-based transaction is conducted on a first communication interface, and the information is received on a second communication interface.

In some embodiments, the second communication interface is associated with longer-range communication compared to the first communication interface.

In some embodiments, the application-based transaction comprises an application-requesting transaction or an application-purchasing transaction.

In some embodiments, a device is provided for processing application-based transactions. The device comprises a first communication interface; a second communication interface; and a processor configured to: receive a first request from a user of the device, the first request being associated with an application; conduct, over the first communication interface, a first transaction, the first transaction comprising transmission or reception of first information over the first communication interface, and send, over the second communication interface, a second request associated with the application. The first request or the second request is processed based on: determining a location associated with conducting the first transaction or sending the second request, and determining the location is an approved location associated with the application.

In some embodiments, the first communication interface comprises at least one of a Bluetooth interface, a near-field communication (NFC) interface, a code-based interface, or a Wi-Fi interface.

In some embodiments, the second communication interface comprises a Wi-Fi or cellular interface.

In some embodiments, the first communication interface and the second communication interface are the same communication interface.

In some embodiments, the second request comprises at least one of a purchase request, the first request, or the first information.

In some embodiments, the location is determined based on global positioning system (GPS) coordinates of the device.

In some embodiments, the device comprises a mobile device or a non-mobile device.

In some embodiments, the second request is approved further based on determining a period of validity associated with the first information has not expired.

In some embodiments, the second request is approved further based on: determining an authority associated with the application; and determining the user is located in an approved jurisdiction associated with the authority for the application.

In some embodiments, the second communication interface is associated with longer range communication compared to the first communication interface.

In some embodiments, the location is determined by at least one of the device or by a second device that receives the second request from the device.

In some embodiments, a method is provided for processing application-based transactions. The method comprises receiving information associated with an application-based transaction conducted between a user device and an application-based terminal, wherein the application-based transaction is associated with a request for executing an application; determining a location of the user device associated with the application; determining the user device is located in an approved location associated with the application; and processing the application-based transaction based on determining the user device is located in the approved location associated with the application. The application-based transaction is conducted on a first communication interface, and the information associated with the application-based transaction is received on a second communication interface.

In some embodiments, the first communication interface comprises at least one of a Bluetooth interface, a near-field communication (NFC) interface, or a code-based interface.

In some embodiments, the application comprises a lottery application.

In some embodiments, the method further comprises determining a period of validity associated with the information has not expired, and processing the application-based request based on determining the period of validity associated with the information has not expired.

In some embodiments, the method further comprises processing the application-based transaction based on: determining a merchant associated with the location of the user device or the application-based terminal; cross-referencing a list of approved merchants associated with the location of the user device or the application-based terminal; and determining the merchant is present on the list of approved merchants.

In some embodiments, the application-based terminal comprises either an electronic application-based terminal or a non-electronic application executing terminal.

In some embodiments, a device is provided for processing application-based transactions. The device is configured to: receive information associated with an application-based transaction conducted between a user device and an application-based terminal, wherein the application-based transaction is associated with a request for executing an application using the user device; and process the application-based transaction based on determining the user device is located in an approved location associated with the application, wherein the location of the user device is determined either by the device or the user device. The application-based transaction is conducted on a first communication interface, and the information is received on a second communication interface.

In some embodiments, the first communication interface comprises at least one of a Bluetooth interface, a near-field communication (NFC) interface, or a code-based interface.

In some embodiments, the application-based transaction comprises an application-requesting transaction or an application-purchasing transaction.

In some embodiments, a non-transitory computer readable medium may be encoded thereon with a program or code that when executed by a processor of a user device, causes the processor to perform the various methods described herein.

These and other advantages of the present disclosure will become apparent to those skilled in the art from the following detailed description, the accompanying drawings, and the appended claims.

### BRIEF DESCRIPTION OF THE DRAWINGS

FIG. 1 is a schematic diagram illustrating a system environment.

FIG. 2 is a flow diagram illustrating a method for processing application-based transactions.

### DETAILED DESCRIPTION

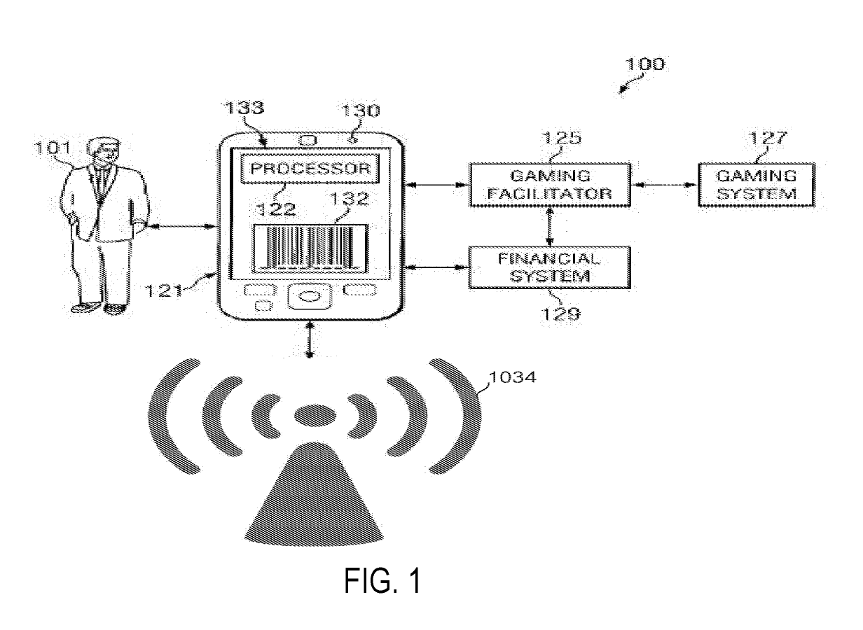

Referring now to FIG. 1, in some embodiments, the device 121 (either a mobile device or a non-mobile device) comprises a first communication interface for communicating with a game-playing terminal 1034. In some embodiments, the game-playing terminal 1034 may be at a gas station. For example, the game-playing terminal 1034 may be integrated into a gas pump or be near a gas pump. Additionally or alternatively, the game-playing terminal 1034 may be located in a store in the gas station. Additionally or alternatively, the game-playing terminal 1034 may be a point-of-sale device, a kiosk, an ATM machine, a coupon terminal, an arcade game-playing machine, a vending machine, etc. In some embodiments, the device 121 may comprise or be comprised in a motor vehicle. The first communication interface comprises a Bluetooth Low Energy (BLE) interface. The game-playing terminal 1034 may be either an electronic or non-electronic terminal and may transmit a code to the device 121 over the first communication interface. Codes from the game-playing terminal 1034 may be transmitted continuously or during certain periods of time (e.g., when activated). A code transmitted from the game-playing terminal 1034 may be a unique identifier for the game-playing terminal 1034. The reception of the code by the device 121 and/or the transmission of the code by the game-playing terminal 1034 may be referred as a transaction conducted between the device 121 and the game-playing terminal. Once the code is received by the device 121, the device 121 sends a request to at least one of the gaming facilitator 125 or the financial system 129. The request may be sent via a second communication interface (e.g., a Wi-Fi or cellular interface). The second communication interface may be associated with longer range communication compared to the first communication interface. The request may be processed based on the location of the device 121 associated with conducting the transaction or sending the request being an approved location associated with the game. The request may be processed by at least one of the device 121, the game-playing terminal 1034, the gaming facilitator 125, or the financial system 129. The location may be determined by the device 121, by the game-playing terminal 1034, by the gaming facilitator 125, or the financial system 129. In some embodiments, the location of the device 121 may be determined using GPS coordinates of the device 121. Multi-factor authentication may be used to determine the location of the device 121. For example, the location of the game-playing terminal 1034 (e.g., the identity of the game-playing terminal 1034) may be used along with the GPS coordinates of the device 121 to determine the location of the device 121.

In some embodiments, the device 121 receives a request from a user of the device. The request may be a game-playing request or a game-purchasing request. Either request may be associated with a mobile game-playing application. In some embodiments, the mobile game-playing application is initiated on the device 121 upon detecting the presence of the game-playing terminal 1034 within the proximity of the device 121 (e.g., upon detecting a code received at the device 121 from the game-playing terminal 1034). In some embodiments, the device 121 may be configured to prompt a user to play a game on the mobile device in response to determining the device 121 is within a threshold distance (e.g., radius) of the game-playing terminal 1034. In some embodiments, the request transmitted via the second communication interface may comprise at least one of the request received from the user of the device or the code received from the game-playing terminal 1034. In some embodiments, the request is processed (e.g., approved) based on determining a period of validity associated with the code received from the device 121 has not expired. In some embodiments, the request is further processed (e.g., further approved) based on determining a gaming authority associated with the game, and determining the user is located in an approved jurisdiction associated with the gaming authority for the game.

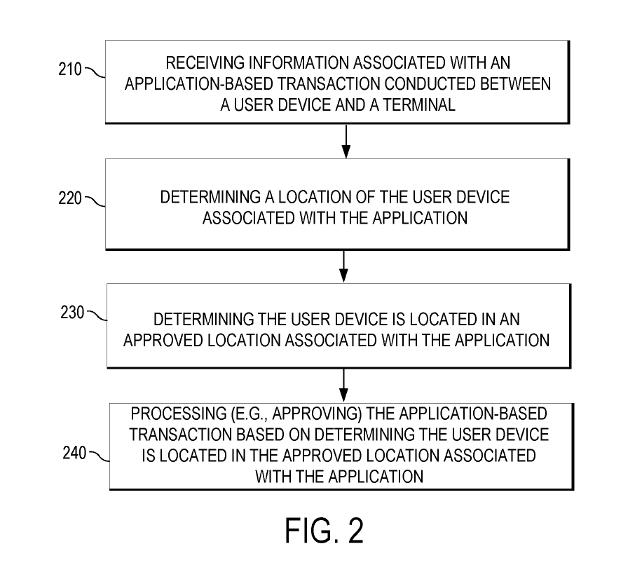

Referring now to FIG. 2, FIG. 2 presents a method for processing application-based transactions. In some embodiments, an application-based transaction may be a game-playing transaction. In some embodiments, an application may be a game. At block 210, the method comprises receiving (e.g., on a second communication interface) information (e.g., from a user device) associated with an application-based transaction conducted via a first communication interface such as a BLE interface, between a user device and an application-based terminal. In some embodiments, a BLE interface may refer to any form or type of Bluetooth technology. A BLE interface is not limited to any particular minimum or maximum communication range. A BLE interface is also not limited to any particular minimum or maximum energy. In some embodiments, the wireless interface may be replaced with a wired interface. In some embodiments, both the first communication interface and the second communication interface may be the same communication interface such that the information is received via the same communication interface on which the application-based transaction is conducted. The application-based transaction is associated with a request for executing an application. At block 220, the method comprises determining a location of the user device associated with the application. In some embodiments, the location of the user device is determined by at least one of the user device, the application-based terminal, or the device that receives (e.g., from the user device) information associated with the application-based transaction. At block 230, the method comprises determining the user device is located in an approved location associated with the application. This determination may be made by the user device or by the device that receives the information associated with the application-based transaction. At block 240, the method comprises processing (e.g., approving) the application-based transaction based on determining the user device is located in the approved location associated with the application. In some embodiments, processing the application-based transaction is based on determining an identity of the merchant or application-based terminal associated with the location of the user device or the application-based terminal. Once the identity of the merchant or application-based terminal is determined, the application-based transaction is approved based on determining the identified merchant or application-based terminal is on a list of approved merchants or application-based terminals. In some embodiments, the application-based terminal (or the merchant) may be identified by accessing a correlation matrix and looking up a corresponding merchant (or application-based terminal).

The present application incorporates-by-reference the entirety of U.S. application Ser. No. 13/757,512, filed Feb. 1, 2013, published as US 2013/0196733, titled “Systems and Methods for Integrated Game Play Through the Use of Proximity-Based Communication on Smart Phones and Hand Held Devices,” for all purposes.

The present application incorporates-by-reference the entirety of U.S. Application No. 61/593,762, filed Feb. 1, 2012, titled “SYSTEMS AND METHODS FOR INTEGRATED GAME PLAY AND SALES OF STATE SPONSORED LOTTERY PRODUCTS THROUGH THE USE OF NEAR FIELD COMMUNICATION ON SMART PHONES AND HAND HELD DEVICES,” for all purposes.

The present application incorporates-by-reference the entirety of U.S. application Ser. No. 14/018,276, filed Sep. 4, 2013, published as US 2014/0066194, titled “Systems and Methods for Integrated Game Play Through the Use of Barcodes on Smart Phones and Hand Held Devices,” for all purposes.

The present application incorporates-by-reference the entirety of U.S. Application No. 61/696,533, filed Sep. 4, 2012, titled “SYSTEMS AND METHODS FOR INTEGRATED GAME PLAY THROUGH THE USE OF BARCODES ON SMART PHONES AND HAND HELD DEVICES,” for all purposes.

The present application incorporates-by-reference the entirety of U.S. application Ser. No. 14/958,715, filed Dec. 3, 2015, titled “PROCESSING OF A MOBILE DEVICE GAME-PLAYING TRANSACTION BASED ON THE MOBILE DEVICE LOCATION,” for all purposes.

The present application incorporates-by-reference the entirety of U.S. application Ser. No. 14/958,720, filed Dec. 3, 2015, titled “PROCESSING OF A MOBILE DEVICE GAME-PLAYING TRANSACTION CONDUCTED BETWEEN THE MOBILE DEVICE AND A BLUETOOTH TERMINAL,” for all purposes.

The present application incorporates-by-reference the entirety of U.S. application Ser. No. 13/842,709, filed Mar. 15, 2013, published as US 2014/0274314, titled “Systems and Methods for Integrated Game Play at Payment-Enabled Terminals,” for all purposes.

While various embodiments in accordance with the disclosed principles have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any invention(s) in this disclosure. Neither is the “Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings herein.

1-11. (canceled)

12. A communication enabled device comprising an integrated circuit, the integrated circuit being removable from the communication enabled device, the integrated circuit comprising device-specific information associated with the communication enabled device, the communication enabled device comprising at least one cache, the cache being used for storing information such that the information is rapidly accessible by the communication enabled device, the communication enable device configured to download one or more applications, the communication enabled device comprising an input system for receiving input into the communication enabled device, the communication enabled device using application logic to display, based on the input and using the one or more applications, the information on a display of the communication enabled device.
